(19) United States
(12) Patent Application Publication
(10) Pub. No.: US 2005/0066305 A1
(43) Pub. Date: Mar. 24, 2005

(54) Method and machine for efficient simulation of digital hardware within a software development environment

(76) Inventor: Robert John Lisanke, Saratoga, CA (US)

Correspondence Address: Robert Lisanke, P.O. Box 2187, Saratoga, CA, 95070-0187, US

(21) Appl. No.: 10/945,281

(22) Filed: Sep. 20, 2004

Related U.S. Application Data
(60) Provisional application No. 60/504,815, filed on Sep. 22, 2003.

(51) Int. Cl. G06F 9/44

(52) U.S. Cl. 717/104; 717/135

(57) ABSTRACT

The invention provides run-time support for efficient simulation of digital hardware in a software development enviromnent, facilitating combined hardware/software co-simulation. The run-time support includes threads of execution that minimize stack storage requirements and reduce memory-related run-time processing requirements. The invention implements shared processor stack areas, including the sharing of a stack storage area among multiple threads, storing each thread's stack data in a designated area in compressed form while the thread is suspended. The thread's stack data is uncompressed and copied back onto a processor stack area when the thread is reactivated. A mapping of simulation model instances to stack storage is determined so as to minimize a cost function of memory and CPU run-time, to reduce the risk of stack overflow, and to reduce the impact of blocking system calls on simulation model execution. The invention also employs further memory compaction and a method for reducing CPU branch mis-prediction.

### CROSS-REFERENCE TO RELATED APPLICATIONS

This application claims priority from U.S. Provisional Application Ser. No. 60/504,815 filed on Sep. 22, 2003, the disclosure of which is incorporated herein by reference.

### BACKGROUND OF THE INVENTION

The invention is a method and machine for simulating digital hardware within a software development environment, enabling combined hardware/software simulation, also referred to as “system-level simulation.”

Simulation has been used to verify and elucidate the behavior of hardware systems. Recently, simulation of hardware and software together has been a goal of these digital simulators. However, software development is usually performed using a language compiler (such as C, C++) with a run-time library that has little or no support for modeling or simulation of hardware components. Proposed solutions to the problem include libraries that allow simulation of hardware within a software development environment by supplying a library of additional procedures, intended mainly to facilitate the execution of concurrent programs, each of which represents a model of a hardware component (simulation model instance).

Although run-time support for simulation must support concurrency in an efficient way, current implementations of hardware simulation using run-time libraries in a software development environment rely on standard thread implementations, intended for software-only system development. Moderately complex hardware simulations consist of hundreds of thousands or millions of components running concurrently. The threading methods currently in use by these thread packages is not memory-efficient enough to simulate even a moderately complex digital hardware design when the hardware is modeled at a low level of abstraction (gate-level or register-transfer-level).

Making use of an existing user-level threads package simplifies the implementation of systems; however, these packages are not appropriate for use in the simulation of hardware because of significant differences between hardware simulation tasks and typical software tasks: standard user-level threads packages assume that threads will be created and destroyed regularly. With hardware simulation, threads are usually created at the beginning of the simulation, and they persist for the entire simulation (physical hardware doesn't disappear and reappear). Hardware models as gates usually have very little local storage, often only a few bytes of automatic storage for temporary variables, and the memory requirements from one thread activation to another are more predictable. A hardware simulation may have hundreds of thousands or even millions of such components. Most multi-threaded software applications make use of only tens or hundreds of threads at any one time.

A processor stack area must be large enough to handle the local data of all nested function or subprogram calls, including interrupts and signals that are “delivered” to the thread. Simply allocating a small processor stack area would not be an acceptable solution: it would fail to account for these additional requirements, possibly resulting in a “stack overflow” condition, causing either problems for or a complete failure of the simulation.

Finally, there has been little or no effort to reduce the impact of system-level overhead when providing run-time support for hardware simulation. In particular, CPU branch mis-prediction and blocking system calls present formidable challenges to efficient simulation. Branch mis-prediction results from a thread that calls into a switch but which returns to different code for another thread (the CPU branch predictor expects a return back to the calling code). Blocking occurs when blocking system calls are interspersed, rather than isolated from, simulation code. These calls block the simulation from further computation until the I/O completes (I/O may require an average of several orders of magnitude more time than what is required to simply compute the data).

### BRIEF SUMMARY OF THE INVENTION

The invention provides a run-time library for simulation of hardware in a software development environment that supports, potentially, a very large number of concurrent threads of execution (hundreds of thousands or millions) with memory requirements that are compatible with the available random-access memory (RAM) found on a standard computer workstation or PC (typically 0.25 to 16 Megabytes). This high degree of concurrency is obtained by employing a memory-efficient threading method for threads that model hardware within the software environment. The invention uses intelligent management of simulation model instance data to overcome many of the limitations of current thread-based simulation systems. The invention also manages data for simulation kernel tasks and for system-level tasks such as I/O. The data management methods of the invention reduce the memory requirements of thread-based hardware simulation, they reduce the likelihood of a stack overflow condition, and they reduce “blocking behavior” of system-level and I/O tasks.

While a thread is active, it is given access to a large processor stack to allow for execution of nested or recursive function calls in addition to signals and interrupts, which are ordinarily processed using the stack of the currently active thread. While a thread is suspended, it no longer needs an entire stack allocation, and its essential local data may be extracted, compressed, and saved until the thread is reactivated or resumed. Processor stack areas essentially become shared among multiple threads corresponding to simulation model instances. This has the added benefit of allowing fewer, larger stack areas, which reduces the risk of stack overflow and which reduce wasted memory that results when only a small part of a stack area contains local data.

Processor stack areas that are shared among multiple threads make up a hierarchy of stack areas that allow trade-offs between processing efficiency and memory efficiency. This trade-off is made based on the available memory and by evaluating a cost function that estimates the relative cost of sharing stack areas and the benefit of saving memory. The cost function, along with memory constraints, determines the number of processor stack areas and the assignment of threads to stack areas. Often, it is possible both to conserve memory and to improve run-time performance: for example, cache-misses and page faults are each affected by memory usage above a certain threshold. The management method for stack data of module instances is analogous to and delivers similar benefits as methods that cache frequently used data.

Blocking behavior is automatically removed from the evaluation of the simulation models, and a producer-consumer synchronization that is part of the simulation kernel transfers simulation values to the I/O threads. Switching back and forth between hardware model code and simulator/software code may be facilitated with separate, dedicated stack areas that do not require a deep copy to perform the thread switch. Separate stack areas serve to organize the design into a hierarchy of stack areas and sub-stack areas where the a combination of deep copy thread switches and processor stack switches optimizes both performance and memory usage, according to a user-specified function and according to accumulation and analysis of run-time statistical data.

Additionally, the invention selects the best simulation instance to activate, according to multiple criteria, from among the instances which may be activated within the partial ordering normally established by the event-driven simulation paradigm. This has the effect of reducing CPU branch mis-prediction and of making efficient use of cached module instance data. For example, grouping and ordering ready-to-run threads by their simulation model causes more thread switches to return to the caller, as expected by the branch predictor. Event handlers are also grouped by model for the same reason: the callback will be more likely to contain the predicted branch target.

Finally, and importantly, the support for hardware simulation is possible within any software development environment, without the requirement for a specific compiler or development tool. Simulation with the user's own software development is a great advantage: the user need not purchase, learn, or otherwise depend on unfamiliar development tools to perform hardware simulation along with software development.

### BRIEF DESCRIPTION OF DRAWINGS

FIG. 1 is a block diagram illustrating the system-level simulator machine comprising: Simulator Kernel 1, a Thread-based Concurrency Means 2, Stack Logical Storage Areas 3, Instructions for Simulation Models 4, Thread-specific Logical Storage Areas 5, an Instance Data Manager 6, a Mapping of Simulation Model Instances to Thread Storage Areas 7, Simulation Model Instance-specific Storage Areas 8, a link 9 representing transfer of data and/or control between the Simulator Instructions 1 and the Instance Data Manager 6, a link 10 representing transfer of data and/or control between the Stack Logical Storage Areas 3 and the Instance Data Manager 6, a link 11 representing transfer of data and/or control between the Mapping of Simulation Model Instances to Thread Storage Areas 7 and the Instance Data Manager 6, a link 12 representing transfer of data and/or control between the Simulation Model Instance-specific Storage Areas 8 and the Instance Data Manager 6.

FIG. 2 is a flow chart illustrating the simulation method comprising: Selecting the Best Model Instance or Simulation Kernel Task and Designating the Instance as “Current” 20, Selecting the Thread and Stack Area to use for Current 21, Restoring the Instance Data of Current to the Thread and Stack Areas 22, Restoring the State of the Thread Corresponding to Current 23, Executing the Instructions of Current until a Wait Instruction is Executed 24, Compressing and Saving the Instance Data of Current 25, Compressing and Saving the Corresponding Thread's State Data 26, Updating the Mappings and Storage Allocations 27, and Returning from the Method When No Additional Tasks Need be Performed 28.

### DETAILED DESCRIPTION

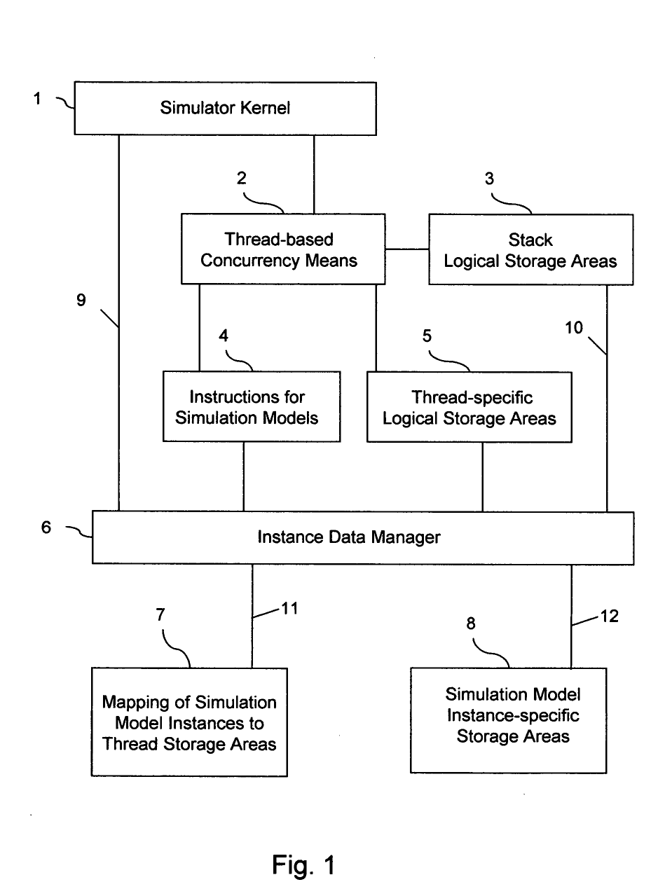

An embodiment of the invention is depicted by the block diagram of FIG. 1. A Simulation Kernel 1 is responsible for causing the execution, in a dynamically ordered sequence, of one or more of the Instructions for Simulation Models 4, acting on the instance-specific data of model instances which are managed by the Instance Data Manager 6 and stored in the Instance-Specific Storage Areas 8.

While a simulation model or kernel task is executing, it runs as a thread of execution under a Thread-based Concurrency Means 2. The Thread-based Concurrency Means 2 provides the executing model or kernel task with a Stack Logical Storage Area 3 which is accessible through a CPU stack-pointer or stack pointers and which provides a convenient way to implement automatic storage for local variables and parameter passing, as is common in modern computer systems. Each thread of the Thread-based Concurrency Means 2 must also maintain a small amount of storage to be able to correctly suspend and re-activate the thread on demand. This additional data is held in the Thread-specific Logical Storage Area 5. The storage areas mentioned are designated as “logical” storage areas, since they may all be part of the same physical memory system. They may be viewed as allocations of memory for a specific purpose. It is also worthwhile to point out that simulation instances may have their own non-stack-oriented data. This type of data is easily managed, and the invention deals, instead, with the difficult problem of managing the stack data of executing model instances.

Normally, the system described so far would be sufficient for the simulation of digital logic within a software environment. However, the Instance Data Manager 6 operating in conjunction with the Mapping of Simulation Model Instances to Thread Storage Areas 7, along with the additional responsibilities of the Simulation Kernel 1, all work together to provide additional efficiency, especially efficiency of memory and storage. The link 9 between the Simulation Kernel 1 and the Instance Data Manager 6 enables the Simulation Kernel 1 to select an instance to run from among instances that are potentially runable. The link 9 also allows the Simulation Kernel 1 to command the Instance Data Manager 6 to load instance-specific data contained in the Instance-specific Storage Areas 8 using link 12, into the Stack Logical Storage Areas 3 using link 10 whenever the appropriate data is not already available in 3. The system effectively shares stack areas among multiple model instances, rather than dedicating an entire stack area to a single model instance, the latter found in the present state of the art.

To determine the location within the Stack Logical Storage Areas 3 to use, the Instance Data Manager 6 consults the Mapping of Simulation Model Instances to Thread Storage Areas 7, accessing it across link 11. It is even possible to share a single stack area within 3 among all instance-specific data held in 8. In this case the number of stack areas required for 3 would be one. Again, a main point of the invention is that instead of dedicating one stack area per simulation instance, each stack area of 3 may be shared among multiple instances, greatly reducing the amount of wasted memory. A many-to-one mapping of model instance data areas to stack areas is therefore provided by 7.

The stack sharing operations of the invention are similar to the problem of caching data, and methods from that area that are well known may be applied to the Mapping system 7 and Data Manager 6, which then treat the Stack Areas 3 as cache memory, and the Instance-specific Storage 8 as backing storage. The over-arching principle that guides the simulation and increases efficiency is that the more frequently used instance data should remain in the Stack Area 3, and less frequently used should be evicted from the Stack Area 3 and saved in the Instance-specific Storage Areas 8, possibly in compressed form.

It is usually valuable to dedicate at least one thread and a stack area within 3 to I/O processing so that the simulation does not block waiting for I/O completion: this includes operation such as writing data to a file or other similar operating-system level tasks.

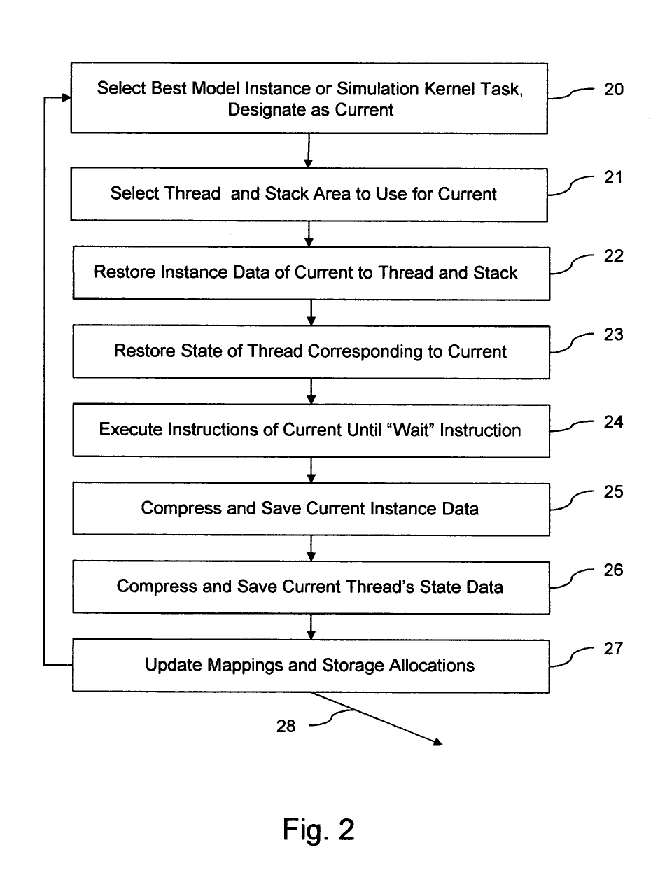

The flow chart of FIG. 2 outlines the simulation method used. The step Selecting the Best Model Instance or Kernel Task and Designate it as “Current” 20 uses multiple criteria to make the selection:
1. As with all simulators, the instance must be in a “ready to run” state.
2. The selection aims to avoid unnecessary transfers of data along links 10 and 12.
3. The model selected is the code that would be predicted by the CPU branch predictor.

With the selected model instance designated as “Current,” the step Select Thread and Stack Area 21 uses any of a number of well-known caching algorithms to determine which stack area within 3 to use, possibly causing the eviction of a previous mapping, along with an update of the mapping within 7. When the stack area of 3 does not contain valid instance data for Current, it must be copied from 8 into 3 as part of the step Restore Instance Data of Current 22. If the data was stored in compressed form, it must also be uncompressed by step 22. The step Restore State of Thread 23 uses information stored in 5 to bring the CPU state to exactly the same as when the instance Current was last suspended. Step 23 includes thread-specific actions such as the restoration of CPU registers, applied to the resumption of Current. In step Execute Instructions of Current until Wait 24, the model code, along with the instance-specific data, is executed until a wait is encountered, usually causing a modification of the data of Current. When a wait is encountered, it causes the Current instance to suspend. At this time, the step Compress and Save Current Instance Data 25 does, when necessary, the compressing and storing of instance-specific data of Current that is contained in storage area 3, back into area 8. However, it is not always necessary to perform either the compression or storage during step 25: compression may only be worthwhile for infrequently activated instances and storage in 8 may not be necessary if the instance data is determined by 6 to remain in area 3. The step Compress and Save Current Thread's State Data 26 is analogous to step 25. The thread data holds any non-stack information related to the thread. It must be saved when necessary by step 26. The step Update Mappings and Storage Allocations 27 relies on the information accumulated during the simulation run that allows the simulator to improve its efficiency as time goes forward: The number of storage areas and size of each storage area within 3 may be increased or decreased by step 27. The mapping of model instances and kernel tasks to threads held by 7 may be updated by step 27. For example, a model instance that is frequently activated may be given its own dedicated stack area so that no copying is required in order to restore and re-activate the instance. Finally, when no more instances or kernel tasks are available to run, the program exits with branch 28.

1. A machine for system-level simulation comprising a simulation kernel, a thread-based concurrency means, a plurality of stack logical storage areas, and a plurality of thread-specific data areas whereby a plurality of simulation model instances of simulation models of hardware or software components may be simulated.

2. The machine of claim 1, further comprising an instance data manager, a plurality of model instance data storage areas, a many-to-one mapping means of said plurality of model instance storage areas to said plurality of stack logical storage areas whereby said stack plurality of stack logical storage areas require substantially fewer areas due to said many-to-one mapping means.

3. The machine of claim 2, wherein the size of each area of said stack logical storage areas is increased whereby stack overflow is substantially reduced.

4. The machine of claim 2, wherein said many-to-one mapping means changes dynamically during simulation according to the frequency of activation of said simulation model instances such that a set of most frequently activated instances of said model instances remain or are held for a longer duration in said stack areas whereby simulation efficiency is improved.

5. The machine of claim 2, wherein said many-to-one mapping means changes dynamically according to a cache management method whereby simulation efficiency is improved.

6. The machine of claim 2, wherein said plurality of stack logical storage areas include a plurality of areas designated for high-latency or blocking threads of execution whereby overlapped execution minimizes negative effects of said high-latency threads.

7. The machine of claim 6, wherein said many-to-one mapping means changes dynamically during simulation according to the latency of said simulation model instances such that a set of high latency instances of said model instances are held in said plurality of high-latency areas within said plurality of stack logical storage areas whereby simulation efficiency is improved.

8. A method for system-level simulation comprising selecting a simulation model instance, selecting a particular thread stack storage area from among a plurality of stack storage areas, selecting a particular thread data area from among a plurality of thread data areas, and executing instructions of said simulation model instance within a context of said particular thread stack storage area until executing a wait instruction whereby a simulation result is computed.

9. The method of claim 8 further comprising copying data contained within said plurality of thread stack storage areas to selected areas within said plurality of simulation model instance storage areas and copying data contained within said plurality of simulation model instance storage areas to selected areas within said plurality of thread stack storage areas whereby said selected stack storage areas may be saved and restored on demand.

10. The method of claim 9 including providing a criteria for said selecting a simulation model instance whereby said copying of data to said plurality of thread stack storage areas is substantially optimized and whereby copying of data to said plurality of model instance storage areas is substantially optimized and whereby CPU branch misprediction is substantially optimized.

11. The method of claim 9 including dynamically adding members to said plurality of thread stack storage areas and dynamically deleting members from said plurality of thread stack storage areas whereby usage of said plurality of thread stack storage areas is optimized.

12. The method of claim 9 including compressing data of said plurality of thread stack storage areas whereby copying data from said plurality of thread stack storage areas is optimized.

13. The method of claim 9 including updating a mapping of members of said plurality of model instance storage areas to members of said plurality of thread stack storage areas whereby sharing of said plurality of thread stack storage areas is optimized.

14. The method of claim 13 including recording usage of said plurality of thread stack storage areas during simulation whereby said mapping of members of said plurality of model instance storage areas to members of said plurality of thread stack storage areas is improved in quality.
